(19) United States
(12) Patent Application Publication
(10) Pub. No.: US 2017/0034108 A1
(43) Pub. Date: Feb. 2, 2017

(54) DETERMINING EVENT RECOMMENDABILITY IN ONLINE SOCIAL NETWORKS

(71) Applicant: Facebook, Inc., Menlo Park, CA (US)

(72) Inventors: Dan Ionut Fechete, Mountain View, CA (US); Jun Jiang, Menlo Park, CA (US); Yang Qin, Menlo Park, CA (US); Zhong Zhang, Fremont, CA (US)

(21) Appl. No.: 14/814,382

(22) Filed: Jul. 30, 2015

(51) Int. Cl. H04L 12/58; H04L 29/08

(52) U.S. Cl. CPC H04L 51/32; H04L 67/306

(57) ABSTRACT

In one embodiment, a method includes, by a computing device, identifying an event in an online social network to be evaluated for recommendation to a user of the online social network and determining whether the event is recommendable to the user, the determination being based on identifying correlations between one or more characteristics of the user and a plurality of signals associated with the event. The method further includes, in response to determining that the event is recommendable, presenting a recommendation or promotion for the event to the user, and, in response to determining that the event is not recommendable, converting the event in accordance with the determining that the event is not recommendable. The signals may include content associated with the event, metadata associated with the event, or responses to a notification about the event by users of the online social network.

### TECHNICAL FIELD

This disclosure generally relates to classification of event-related information in online social networks.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

An events ecosystem in an online social network is meant to be used to promote and manage events that users of the social network can organize and attend, such as concerts, festivals, and other events that occur at particular places and times. The online social network may recommend particular events to users who are likely to be interested in those events. However, users can create false events, with names such as “Party at the President's house in Brazil,” or “Cutest teen of 2015,” which do not correspond to actual events, and therefore should not be recommended to other users. Such false events may be identified by analyzing metadata associated with an event, including the event's description, location, author, a URL for a link presented on a web page associated with the event, and so on. In particular embodiments, information associated with the event may be stored in the content of the event, the metadata of the event, or both. For example, the content of the event may include the event's description, location, author, a URL for a link presented on a web page associated with the event, and so on.

In particular embodiments, false events may be identified based on correlations between the data associated with the events and characteristics of a user to whom the event is to potentially be recommended. For example, if an event's description contains content that is inappropriate for a user, the event should not be recommended to that user. As another example, an event's location may be compared to a user's location, and if there is a correlation, e.g., the event location is near the user's location, then the event may be recommended to the user. If the correlation is weak, e.g., less than a threshold distance, then the event should not be recommended to the user or otherwise promoted. In another example, a text classifier trained to recognize recommendable events based on their content may be used to identify events that should not be recommended. An event that should not be recommended may be processed in another way, e.g., converted to a different type of entity, such as a group users can join, or an event marked “just for fun.”

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3A and 3B illustrates example methods for determining whether an online social-network event is recommendable to a user.

FIG. 4 illustrates an example computer system.

### DESCRIPTION OF EXAMPLE EMBODIMENTS

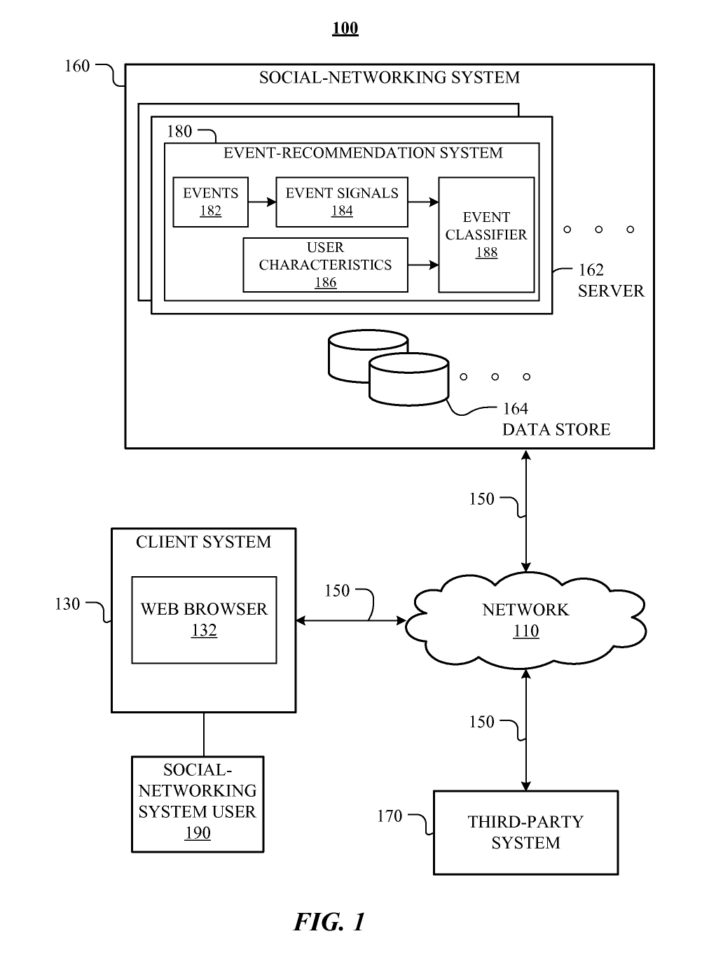

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user 190 at client system 130 to access network 110. A client system 130 may enable its user 190 to communicate with other users 190 at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user 190 at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user 190. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, client system 130 may access social-networking system 160 using a web browser 132, or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 to whom they want to be connected. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

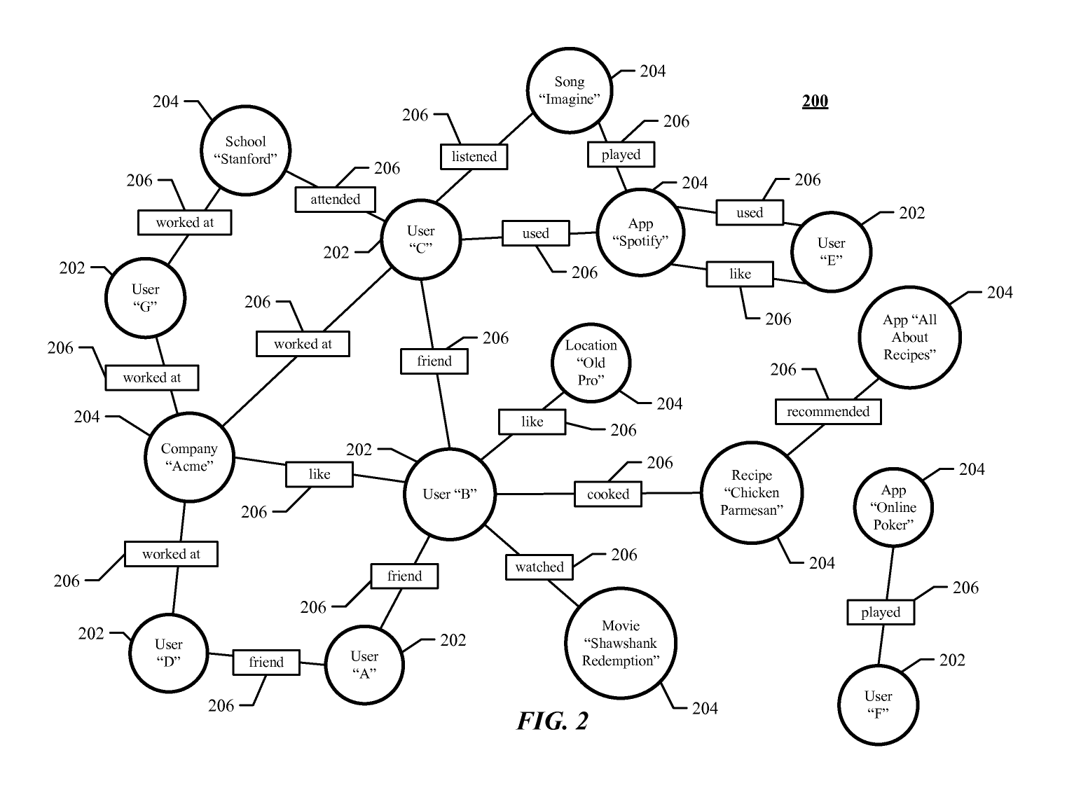

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 160). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 160 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 160) or RSVP (e.g., through social-networking system 160) to an event associated with the advertisement. In addition or as an alternative, an advertisement may include social-networking-system content directed to the user. As an example and not by way of limitation, an advertisement may display information about a friend of the user within social-networking system 160 who has taken an action associated with the subject matter of the advertisement.

In particular embodiments, a social event management system in an online social network may be used by social-network users to promote and manage events 182 such as concerts, festivals, and other events that occur at particular places and times. The social network events 182, which may correspond to real-world events that users 190 of the social networking system 160 can attend, such as concerts, festivals, local events, art galleries, performing arts, wine tasting, things to do, book signings, movie related events, and so on. Users may create the events 182 by providing event information, such as a name, a description of the event 182, and a date at which the event 182 is to occur. A user may then invite other users to “join” (e.g., register or sign up for) the event 202.

In particular embodiments, the social-networking system 160 may identify and recommend particular ones of the events 202 to users who are likely to be interested in those particular events. However, users can create false events that do not correspond to real-world events. An event may be considered false if, for example, there is no actual date and place at which the event is to occur. False events may resemble spam email or memes, and may have names such as “Party at the President's house in Brazil,” or “Cutest teen of 2015,” which do not correspond to actual events. The online social network should identify false events and should not ordinarily recommend them to users. False events may be identified by analyzing data associated with an event, such as the event's content, including the event's description, location, author, and so on. False events may also be identified based on correlations between the data associated with the events and characteristics of a user to whom the event is to potentially be recommended. For example, if an event's description contains content that is inappropriate for a user, the event should not be recommended to that user. As another example, an event's location may be compared to a user's location, and if there is a correlation, e.g., the event location is near the user's location, then the event may be recommended to the user. If the correlation is weak, e.g., less than a threshold distance, then the event should not be recommended to the user or otherwise promoted. In another example, a text classifier trained to recognize recommendable events based on their content may be used to identify events that should not be recommended. An event that should not be recommended may be processed in another way, e.g., converted to a different type of entity, such as a group users can join, or an event marked “just for fun.”

In particular embodiments, an event-recommendation system 180 may determine whether particular social-network events 182 should be recommended to a social-networking system user 190. The system 180 may determine which of the events 182 are likely to be actual, e.g., real-world, events, and which of the events 182 are likely to be false events, and process the events 182 accordingly. In particular embodiments, elements of the event-recommendation system 180 may be implemented as part of a social-networking system. The data associated with the events 182 and the user characteristics 186 may be stored in the data store 164 for access by the event-recommendation system 180. In particular embodiments, elements of the event-recommendation system 180 may be implemented as part of a third-party system.

In particular embodiments, the event-recommendation system 180 may use one or more event-analysis techniques to determine whether the events 182 are likely to be false events. These event-analysis techniques may analyze event signals 184 associated with each of the events 182 to determine if each event is likely to be a false event, and therefore not recommendable. The event signals 184 may include data associated with the events 182, such as content or metadata associated with each event 182. The event signals 184 may also include responses to a notification about the event by users of the online social network. The responses may be, for example, a like of the notification, a forward of the notification, or a rating of the notification, any of which may indicate that the event is recommendable, or hiding the notification, blocking the notification, or noting that the notification is spam, any of which may indicate that the event is not recommendable. The event signals 184 may be retrieved from offline signal data and/or online signal data. The offline signal data may be gathered from an offline data source, such as a data warehouse, once, e.g., when the event recommendation system is initialized, and re-used for multiple events. The online signal data may be gathered and updated in real time, e.g., as events occur. The event-analysis techniques may also analyze the event signals 182 and user characteristics 186 associated with each user 190 to identify correlations between the signals 184 and the user characteristics 186. The correlations may be used to determine whether the events 182 are likely to be false events, and therefore not recommendable. The event-analysis techniques may include text analysis to identify sensitive content associated with events, such as profanity or nudity. The event-analysis techniques may also include geographic distribution analysis to identify events that have locations far from their joiners (e.g., users who have registered to attend the events). For example, when an event that specifies a location occurs, the distance between the event's location and the location of a user may be determined and used to calculate a “recommendable” or “not recommendable” result.

In particular embodiments, the event-analysis techniques may also include event text and image classification using a classifier 188 to classify each of the events 182 as recommendable or not recommendable based on training data. The event-analysis techniques may also include assessment of the credibility of event authors (e.g., based on their affiliated organizations), and assessment of the reputation of event joiners. Each event-analysis technique may, for example, generate a binary indication that a specified event is either recommendable or not recommendable, or a range of values indicating a probability or confidence level that the event is recommendable. If binary indications are used, then the overall result for the event may be determined to be “recommendable” if all of the binary indications are true, or “not recommendable” if at least one of the indications is false. Other metrics based on the binary indications are possible, e.g., the event may be determined to be true if a majority of the indications are true, or false otherwise. In particular embodiments, if each event-analysis technique produces a range of values, e.g., a floating-point indication between 0 and 1, then a weighted average of the indications may be determined, with each event-analysis technique having an associated weight factor, and the weighted average may be compared to a threshold value. The event may be determined to be “recommendable” if the average is greater than the threshold value, or “not recommendable” otherwise. Events 182 that are deemed “recommendable” may be recommended to users, and events deemed “not recommendable” may be handled differently, e.g., by not being recommended, or by being converted to a different type of social-network construct and recommended. The aforementioned event-analysis techniques and ways of combining their results are examples, and other techniques may be used and combined in other ways.

In particular embodiments, text analysis may be used to identify sensitive content. An event's textual information, e.g., the event's name and description, may be analyzed using a text classifier to determine whether the event is recommendable. The text classifier may be implemented using an algorithm that is trained on training data provided by human event raters who read and evaluate events to determine if the events look like real events. The human readers may look at a photo, title, and/or description associated with the event, and indicate whether the event appears to be a real event or a false event. The trained text classifier is used to evaluate events to determine whether the events are recommendable. Characters may be extracted from the event's text character-wise and word-wise (e.g., as n-grams). A number of features are then generated. The features indicate whether a particular sequence of characters is in the description. These features are combined into a feature vector. The text is split into sequences that include, for example, up to 4 adjacent characters length (all sequences of 2, 3, and 4 characters), and all word sequences up to 4 words (other numbers may be used in other examples). The model may determine that most events tagged as not recommendable have identified words. Once the text classifier has been trained, it may be used to evaluate subsequent events as they are initiated by checking the events for the identified words. The text classifier may use per-language text classifiers trained in languages such as English, Spanish, Portuguese, and so on. The text of comments on events may also be evaluated similarly to event names and descriptions, e.g., using a text classifier as described above. As an example and not by way of limitation, a profanity signal may be evaluated by determining if the title or description of the event contains any profanity. If so, the event may be classified as non-recommendable. As an example and not by way of limitation, a nudity signal may be evaluated by using an image classifier to scan a cover photo or other image(s) associated with the event. If the cover photo or other image(s) contains any nudity or sensitive content, the event may be classified as non-recommendable.

In particular embodiments, events that are likely to be meme or spam events may be evaluated based on a real-time joiner geographic distribution. One of the correlations determined between the content of an event and the characteristics of the user may be a distance between the location of the event and the location associated with the user of the online social network. Depending on the distance, the event may be classified as recommendable or non-recommendable. When a user joins the event, distance between the join-time city (in which the joiner is located) and the event's host city is determined and logged. A certain percentage of users who join an event are expected to be from the local city or area in which the event is located. If the percentage of non-local users is beyond a threshold, then the event may be classified as a meme event and deemed not recommendable. Two thresholds are used when evaluating the he joiner geographic distribution: a distance threshold, e.g., 100 km, 500 km, 800 km, or other distance from beyond which people are unlikely to attend an event, and a percentage threshold for the percentage of users who have joined the event from beyond the distance threshold, e.g., 30%, 50%, 70%, etc. If the percentage of people who have joined the event from beyond the distance threshold is greater than the percentage threshold, then the event is considered a meme (or spam). For example, if 70% have joined from beyond 500 km, then the event may be considered spam (or a meme) and not recommendable.

In particular embodiments, non-recommendable (e.g., spam and meme) events may also be detected based on a ratio of the number of direct joiners, e.g., users who have not viewed the event but have registered for it, over the number of joiners who have viewed the event. When users see stories about spam events, they may directly join the event without going to the event page to look at the event's details. For example, a user may join a campaign to win a tablet device without looking into the details of the campaign. A threshold of the ratio can be used. For example, if the ratio is >=0.4, 0.6, 0.8, etc., then the event may be classified as non-recommendable.

In particular embodiments, additional signals may be used to determine whether an event is recommendable. An event's metadata may identify the author of the event, and the author may be used as a signal to determine whether the event was created by a verified author (e.g., user or entity). For example, if the event was created by a large media corporation or other registered organization associated with the verified entity node of the event's author, then the event is likely to be real and may be deemed recommendable. An author's previous event quality may be used as a signal to evaluate the quality of previous events created by the event's author. If the quality of previous events created by the event's author is greater than a threshold (e.g., greater than 90$ of the author's previous events are actual events), then the event is likely to be real and may be deemed recommendable. A verified link signal may be used to determine whether a web link (e.g., a URL) presented on the event page references a verified page, such as a page on an officially-registered website. For example, if the event page has a link to a verified page on a music festival's website, then the event is likely to be real and is deemed recommendable.

In particular embodiments, an author reputation signal may be used to determine whether the event is recommendable. For example, the reputation of the author of the event may be considered good or have a positive impact on the recommendability of the event if the author is affiliated with or employed by a large and/or well-known organization such as a large ticket distributor. A joiner reputation signal may be used to determine reputations of users who have joined the event. An average or other measure based on the reputations of the users who have joined the event may be computed and compared to a threshold value to determine whether the event is recommendable. For example, if the average reputation is greater than a threshold, then the event is likely to be real, and is recommendable.

In particular embodiments, an event that is deemed recommendable to a user may be recommended to that user by, for example, displaying information about the event in a user interface of a web browser or mobile application, and/or adding information about the event to the user's social network news feed, and/or sending information about the event to the user in a message or notification. Users may select an option to not be shown events like a specified event, so that similar events are not recommended to such users.

In particular embodiments, when an event is deemed not recommendable to a user, one or more actions may be taken for the event. A non-recommendable event may be excluded from recommendation or promotion, or may be converted to a social network “group” or other social-networking construct. For example, an event named “Teen of the Year” may be converted to a group, which is a more appropriate social networking construct that has multiple associated users, but does not occur at a specific time or place. A suggestion to convert such an event to a group may be made to the author of the event. In the “Teen of the Year” example, both the joiner distribution and the text classification flag the event as a false event. The joiners are likely to be located at random places, and the text of the event is likely to be classified as non-recommendable. A non-recommendable event may also be categorized, labeled, or flagged appropriately. For example, events that are non-recommendable may be categorized in a category such as “Just for Fun.”

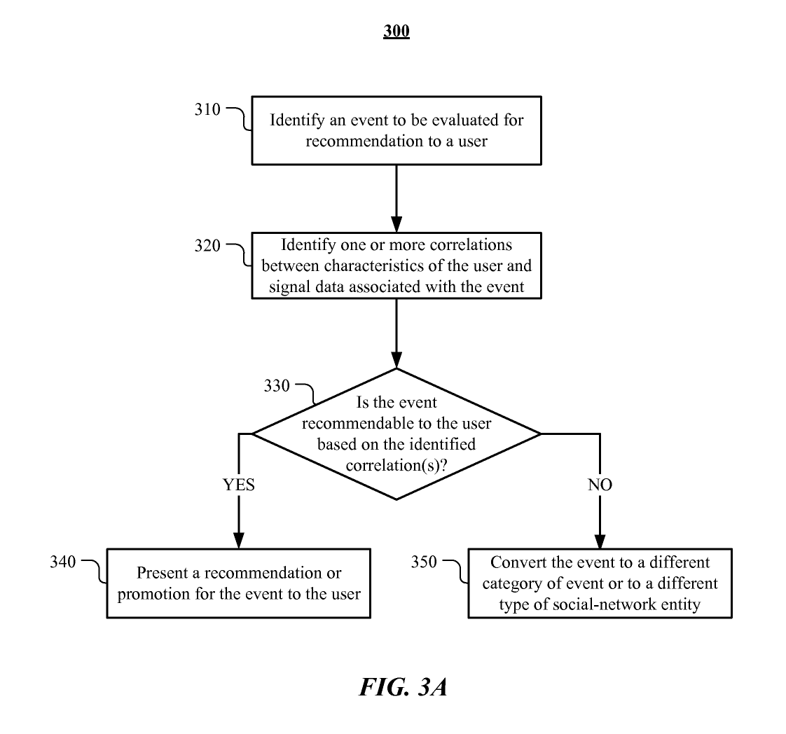

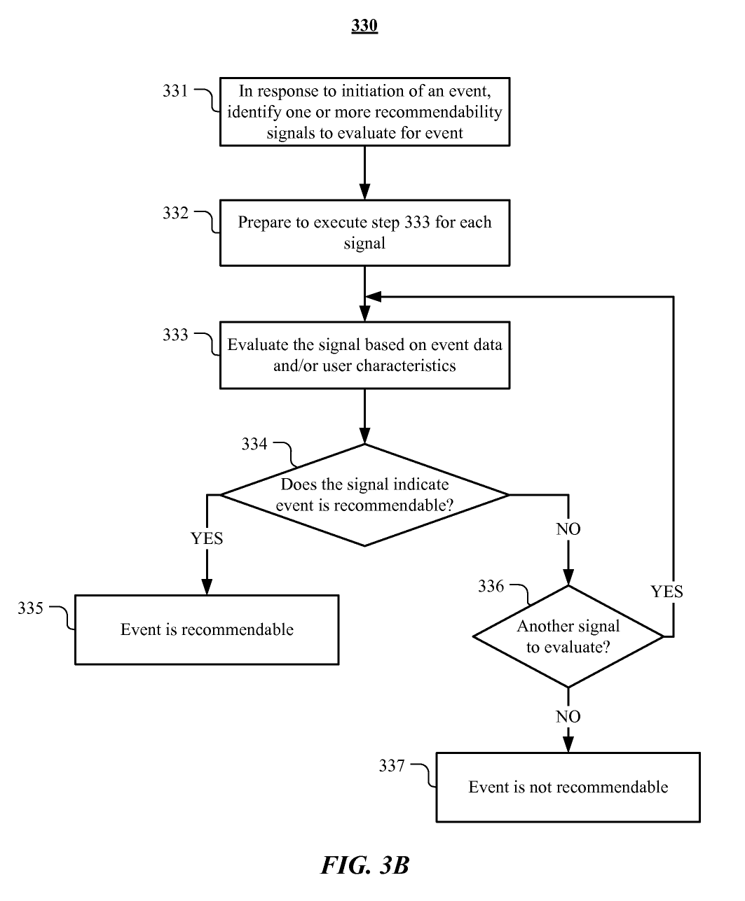

FIG. 3A illustrates an example method 300 for determining whether an online social-network event is recommendable to a user. The method may begin at step 310, where the event-recommendation system 180 identifies an event to be evaluated for possible recommendation to a user, e.g., in response to initiation of the event. Event initiation may occur when the event is created, when people are invited to the event, when the event is publicized or advertised, when the event is posted as a new item on the social network by a user, when the event is to be recommended to a user, and so on. At step 320, the event-recommendation system 180 may identify one or more correlations between characteristics of the user and signal data associated with the event. At step 330, the event-recommendation system 180 may determine whether the event is recommendable to the user based on the identified correlation(s). Further details of step 330 are shown in FIG. 3B. If step 330 determines that the event is recommendable to the user, the event-recommendation system 180 may execute step 340. At step 340, the event-recommendation system 180 may present a recommendation or promotion (e.g., a notification or insertion into the user's newsfeed, or re-ranking of an existing newsfeed item) for the recommendable event to the user. If step 330 determines that the event is not recommendable to the user, the event-recommendation system 180 may execute step 350. At step 350, the event-recommendation system 180 may convert the non-recommendable event to a different category of event, or to a different type of social-network entity.

Particular embodiments may repeat one or more steps of the method of FIG. 3A, where appropriate. Although this disclosure describes and illustrates particular steps of the method of FIG. 3A as occurring in a particular order, this disclosure contemplates any suitable steps of the method of FIG. 3A occurring in any suitable order. Moreover, although this disclosure describes and illustrates an example method for determining whether an online social-network event is recommendable to a user including the particular steps of the method of FIG. 3A, this disclosure contemplates any suitable method for determining whether an online social-network event is recommendable to a user including any suitable steps, which may include all, some, or none of the steps of the method of FIG. 3A, where appropriate. Furthermore, although this disclosure describes and illustrates particular components, devices, or systems carrying out particular steps of the method of FIG. 3A, this disclosure contemplates any suitable combination of any suitable components, devices, or systems carrying out any suitable steps of the method of FIG. 3A.

FIG. 3B illustrates an example method 330 for determining whether an online social-network event is recommendable to a user. The method may begin at step 331, where the event-recommendation system 180 may detect initiation of an event and identify one or more recommendability signals to evaluate for event. Step 331 may be invoked by step 330 of FIG. 3A. At step 332, the event-recommendation system 180 may prepare to execute step 333 and subsequent steps in a loop for each signal. At step 333, the event-recommendation system 180 may evaluate each signal based on event data and/or user characteristics. At step 334, the event-recommendation system 180 may determine whether the signal indicates that the event is recommendable, transferring control to step 335 if so, or to step 336 if not. At step 335, the event-recommendation system 180 may provide an indication that the event is recommendable, e.g., by returning a “recommendable” value from a function that corresponds to the method 330. At step 336, the event-recommendation system 180 may determine whether there is another signal to evaluate in the loop. If so, control transfers back to step 333. If not, at step 337, the event-recommendation system 180 may provide an indication that the event is not recommendable, e.g., by returning a “not recommendable” value from a function that corresponds to the method 330.

Particular embodiments may repeat one or more steps of the method of FIG. 3B, where appropriate. Although this disclosure describes and illustrates particular steps of the method of FIG. 3B as occurring in a particular order, this disclosure contemplates any suitable steps of the method of FIG. 3B occurring in any suitable order. Moreover, although this disclosure describes and illustrates an example method for determining whether an online social-network event is recommendable to a user including the particular steps of the method of FIG. 3B, this disclosure contemplates any suitable method for determining whether an online social-network event is recommendable to a user including any suitable steps, which may include all, some, or none of the steps of the method of FIG. 3B, where appropriate. Furthermore, although this disclosure describes and illustrates particular components, devices, or systems carrying out particular steps of the method of FIG. 3B, this disclosure contemplates any suitable combination of any suitable components, devices, or systems carrying out any suitable steps of the method of FIG. 3B.

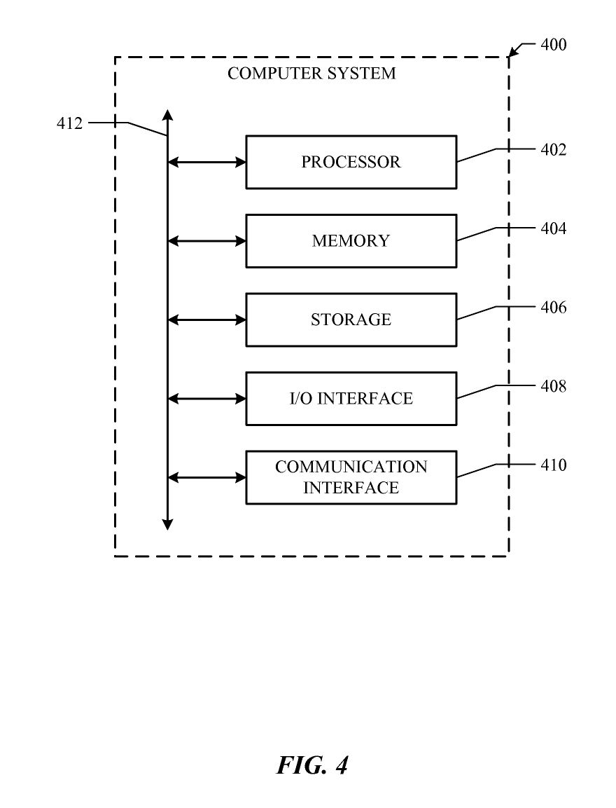

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing device, identifying an event in an online social network to be evaluated for recommendation to a user of the online social network;
by the computing device, determining whether the event is recommendable to the user, the determination being based on identifying correlations between one or more characteristics of the user and a plurality of signals associated with the event;
by the computing device, in response to determining that the event is recommendable, presenting a recommendation or promotion for the event to the user; and
by the computing device, in response to determining that the event is not recommendable, converting the event in accordance with the determining that the event is not recommendable.

2. The method of claim 1, wherein the event is identified for evaluation in response to an initiation of the event.

3. The method of claim 1, wherein the signals comprise:
content associated with the event;
metadata associated with the event; or
responses to a notification about the event by users of the online social network.

4. The method of claim 3, wherein the content associated with the event comprises a location of the event, and the characteristics of the user comprises a location associated with the user.

5. The method of claim 4, wherein the correlations determined between the content and the characteristics of the user comprise a distance between the location of the event and the location associated with the user of the online social network.

6. The method of claim 5, wherein the event is not recommendable to the user when the distance between the location of the event and the location associated with the user is greater than a distance threshold.

7. The method of claim 5, further comprising:
determining that a percentage of registered users who have joined the event and are at current locations at distances greater than the distance threshold from the location of the event,
wherein the event is not recommendable to the user when the percentage is greater than a percentage threshold.

8. The method of claim 3, wherein the metadata associated with the event identifies an author of the event.

9. The method of claim 8, wherein the metadata associated with the event comprises a URL for a link presented on an event page associated with the event, and the URL identifies the author of the event.

10. The method of claim 8, wherein the metadata associated with the event comprises a reputation of the author of the event.

11. The method of claim 3, wherein the responses to the notification about the event by users of the online social network comprise one or more of a like of the notification, a forward of the notification, a rating of the notification, hiding the notification, blocking the notification, or noting that the notification is spam.

12. The method of claim 3, wherein the content associated with the event comprises text data, the method further comprising:
determining, using a text classifier and text classification data generated from training data, whether the event is an actual event or not,
wherein the event is recommendable to the user when the event is an actual event.

13. The method of claim 3, wherein the content associated with the event comprises text data, the method further comprising:
determining, based on profanity identification data, whether the text data contains profanity.

14. The method of claim 3, wherein the content associated with the event comprises image data, the method further comprising:
determining, using an image classifier and image classification data, whether the image data contains nudity or sensitive content.

15. The method of claim 3, wherein the metadata comprises a number of users who have registered for the event without accessing an event page that contains information about the event, and a number of users who have registered for the event and accessed the event page, the method further comprising:
determining a ratio of the number of users who have registered for the event without accessing the event page to the number of users who have registered for the event and accessed the event page,
wherein the event is not recommendable to the user when the ratio is greater than a threshold ratio.

16. The method of claim 1, wherein the converting the event comprises modifying the event to be an online social network group.

17. The method of claim 1, wherein the converting the event comprises categorizing the event in a category associated with non-recommendable events.

18. One or more computer-readable non-transitory storage media embodying software that is operable when executed to:
identify an event in an online social network to be evaluated for recommendation to a user of the online social network;
determine whether the event is recommendable to the user, the determination being based on identifying correlations between one or more characteristics of the user and a plurality of signals associated with the event;
in response to determining that the event is recommendable, present a recommendation or promotion for the event to the user; and
in response to determining that the event is not recommendable, convert the event in accordance with the determining that the event is not recommendable.

19. The media of claim 18, wherein the signals comprise:
content associated with the event;
metadata associated with the event; or
responses to a notification about the event by users of the online social network.

20. A system comprising: one or more processors; and a memory coupled to the processors comprising instructions executable by the processors, the processors being operable when executing the instructions to:
identify an event in an online social network to be evaluated for recommendation to a user of the online social network;
determine whether the event is recommendable to the user, the determination being based on identifying correlations between one or more characteristics of the user and a plurality of signals associated with the event;
in response to determining that the event is recommendable, present a recommendation or promotion for the event to the user; and
in response to determining that the event is not recommendable, convert the event in accordance with the determining that the event is not recommendable.
